(19) United States
(12) Patent Application Publication
(10) Pub. No.: US 2018/0035516 A1
(43) Pub. Date: Feb. 1, 2018

(54) WIRELESSLY-CONTROLLABLE PORTABLE LUMINAIRE

(71) Applicant: PHILIPS LIGHTING HOLDING B.V., EINDHOVEN (NL)

(72) Inventors: IULIA DOBAI, EINDHOVEN (NL); MARTINE GABRIELLE PYTHIA VAN BEERS, NUENEN (NL)

(21) Appl. No.: 15/127,268

(22) PCT Filed: Feb. 27, 2015
(86) PCT No.: PCT/IB2015/051455

§ 371 Date: Sep. 19, 2016

Related U.S. Application Data
(60) Provisional application No. 61/954,070, filed on Mar. 17, 2014.

(51) Int. Cl. H05B 37/02; H04B 5/00; H05B 33/08

(52) U.S. Cl. CPC H05B 37/0272; H05B 33/0845; H05B 33/0857; H04B 5/0031

(57) ABSTRACT

The present disclosure is directed to methods and apparatus for wireless control of a portable luminaire (100, 200, 300). For example, an NFC-enabled luminaire may obtain light settings from one or more NFC components to display one or more light behaviors.

### TECHNICAL FIELD

The present invention is directed generally to wireless control of a luminaire. More particularly, various inventive methods and apparatus disclosed herein relate to control of a portable luminaire based on wireless communication with a wireless transmitter.

### BACKGROUND

Digital lighting technologies, i.e., illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green, and blue, as well as a processor for independently controlling the output of the LEDs in order to generate a variety of colors and color-changing lighting effects.

Radio frequency identification (“RFID”) technologies, i.e., communication between devices based on wireless, contact-free, radio-frequency electromagnetic fields, offer viable options to control RFID-enabled devices. For example, an RFID reader may be included in a luminaire, and a microcontroller may be configured to utilize the RFID reader to read data from an RFID tag. Such data may include the luminaire's MAC address and its maximum lumen output. Likewise, near field communication (“NFC”) technologies, i.e., wireless communication between devices when in close proximity to one another, offer viable options to control NFC-enabled devices. For example, an NFC-enabled toy robot may be controlled to execute a sequence of instructions based on proximity to a passive NFC tag.

NFC may be implemented in various ways. A passive NFC chip can be read from and written to by an active NFC reader/writer or an NFC controller. An NFC reader/writer can read from or write to passive NFC chips. NFC controllers can exchange data with other NFC controllers, e.g., in a peer-to-peer communication paradigm. NFC technologies offer viable options to control semiconductor light sources to provide a plurality of lighting effects. Such NFCs may be utilized to control the processors that, in turn, control the output of the lighting modules. For example, a light source may include an NFC controller. An NFC-enabled smartphone may transfer a light setting to the NFC controller when the smartphone is proximate to the luminaire. The NFC controller may, in turn, induce the light source to execute a lighting sequence based on the light setting. As another example, the light setting may be stored in a passive NFC tag, and an NFC-enabled smartphone may read the light setting when the smartphone is proximate to the NFC tag. The smartphone may then transmit the light setting to a processor that controls the output of a light source, e.g., using NFC or another communication technology such as Wi-Fi or Bluetooth. The processor may, in turn, induce the light source to execute a lighting sequence based on the light setting.

Luminaires may include processors that independently control the output of lighting modules. In some instances, such processors may be pre-programmed with a predetermined light setting and may control the output of the lighting modules based on the predetermined light setting. In many practical applications, it may be desirable to control a luminaire to induce a plurality of lighting behaviors based on the physical location of the luminaire and without use of an intermediate computing device. Thus, there is a need in the art to exchange one or more light settings directly between wireless communication-enabled (e.g., NFC-enabled) components and light sources without the aid of an intermediate device.

### SUMMARY

The present disclosure is directed to inventive methods and apparatus for wireless control of a luminaire. For example, an NFC-enabled LED-based luminaire may retrieve light settings from one or more NFC components to display one or more light behaviors.

Generally, in one aspect, a portable luminaire may include a housing defining an interior. The interior may include one or more LED drivers to energize one or more LEDs based on a lighting control signal, a wireless communication interface to receive a wireless signal from a wireless transmitter, and a controller operably coupled with the one or more LED drivers and the wireless communication interface. The controller may be configured to determine, based on the wireless signal, one or more desired properties of light to be emitted by the one or more LEDs, and generate the lighting control signal based on the one or more desired properties of light.

In various embodiments, the wireless communication interface includes a near field communication reader/writer. In various embodiments, the wireless communication interface comprises a near field communication controller.

In various embodiments, the portable luminaire further includes memory storing a library of lighting scenes. The controller may be further configured to select a lighting scene from the library based on information contained in the wireless signal, and generate the lighting control signal to cause the one or more LED drivers to energize the one or more LEDs to emit light in accordance with the selected lighting scene. In various versions, the lighting scene is a time-dependent lighting scene. In various versions, the portable luminaire further includes a timer set to expire after a predetermined time interval. In various versions, the controller may be further configured to generate the lighting control signal until a first of expiration of the timer or movement of the portable luminaire away from the wireless transmitter, or to generate the lighting control signal after expiration of the timer.

In various embodiments, the controller may be further configured to interpret one or more lighting control parameters or commands contained in the wireless signal, and generate the lighting control signal to cause the one or more LED drivers to energize the one or more LEDs to emit light having properties selected based on the interpreted one or more lighting control parameters or commands.

The wireless communication interface may be configured to exchange data using one or more of radio frequency identification (“RFID”) or BlueTooth.

In various embodiments, the controller may be further configured to transmit, via the near field communication controller to a wireless receiver associated with the wireless transmitter, one or more desired properties of light to be emitted by one or more light sources associated with the wireless transmitter. In various embodiments, the controller may be further configured to transmit, via the near field communication controller to a wireless receiver associated with the wireless transmitter, one or more desired sound effects to be emitted by one or more speakers associated with the wireless transmitter.

Other implementations may include a non-transitory computer readable storage medium storing instructions executable by a processor to perform operations such as those described above. Yet another implementation may include a method of performing operations such as those described above.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable).

The term “light source” should be understood to refer to any one or more of a variety of radiation sources, including, but not limited to, LED-based sources (including one or more LEDs as defined above). A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of approximately 700 degrees K (typically considered the first visible to the human eye) to over 10,000 degrees K; white light generally is perceived at color temperatures above 1500-2000 degrees K.

The terms “lighting fixture” and “luminaire” are used interchangeably herein to refer to an implementation or arrangement of one or more lighting units in a particular form factor, assembly, or package. The lighting fixtures/luminaires may be portable or fixedly mounted and also include wiring that connects the one or more light sources to a power source, as well as an optical element such as a reflector, lens, collimator, etc., that may help direct and distribute the light. A luminaire may also include one or more of a reader/writer and a controller.

The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “RFID” as used herein refers to a set of standards for devices to transfer data wirelessly, and without physical contact, by utilizing radio-frequency electromagnetic fields. The term “NFC” as used herein refers to a set of standards for devices to establish radio communication with each other via physical contact, and/or by bringing them into proximity, usually no more than a few inches. NFC standards cover communications protocols and data exchange formats, and are based on existing RFID standards.

The term “wireless transmitter” as used herein refers to a transmitter that may be active or passive. The wireless transmitter may, for example, be an NFC tag, NFC controller or a Bluetooth low energy (“BT LE”) beacon. An active wireless transmitter refers to a transmitter that may be battery operated. An active wireless transmitter may refer to, for instance, an NFC controller, which may be configured to engage in peer-to-peer communication with other NFC controllers. The term “passive wireless transmitter” as used herein refers to a transmitter that is activated when in the presence of a reader/writer, such as an NFC reader/writer. The reader/writer may send a signal to the passive wireless transmitter, and read data included in the passive wireless transmitter. Generally, a passive wireless transmitter may not include a power source. Further, it should be readily appreciated that a passive wireless transmitter such as an NFC tag may be read only, or may be readable and writable. Generally speaking, NFC tags may include information related to a light behavior such as one or more of light settings (e.g., hue, brightness, intensity, dim, etc.), light effects (e.g., sequences and/or patterns of light settings), sound effects, shapes, textures, and so forth.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates a luminaire in communication with a wireless transmitter.

FIG. 2A illustrates a luminaire displaying a first location-specific lighting behavior in response to a wireless transmitter located at a first location.

FIG. 2B illustrates a luminaire displaying a second location-specific lighting behavior in response to a wireless transmitter located at a second location.

FIG. 3A illustrates a luminaire displaying a first light behavior in response to a first wireless transmitter embedded in a first portion of a play mat.

FIG. 3B illustrates a luminaire displaying a second light behavior in response to a second wireless transmitter embedded in second portion of a play mat.

### DETAILED DESCRIPTION

There is a need in the art to retrieve, read, and/or transfer a light setting directly from an NFC component to a light source, without the aid of an NFC-enabled intermediate device. More generally, Applicants have recognized and appreciated that it would be beneficial to wirelessly control a luminaire based on the luminaire's proximity to an NFC component such as an active NFC controller or a passive NFC tag. In view of the foregoing, various embodiments and implementations of the present invention are directed to wireless control of a portable luminaire.

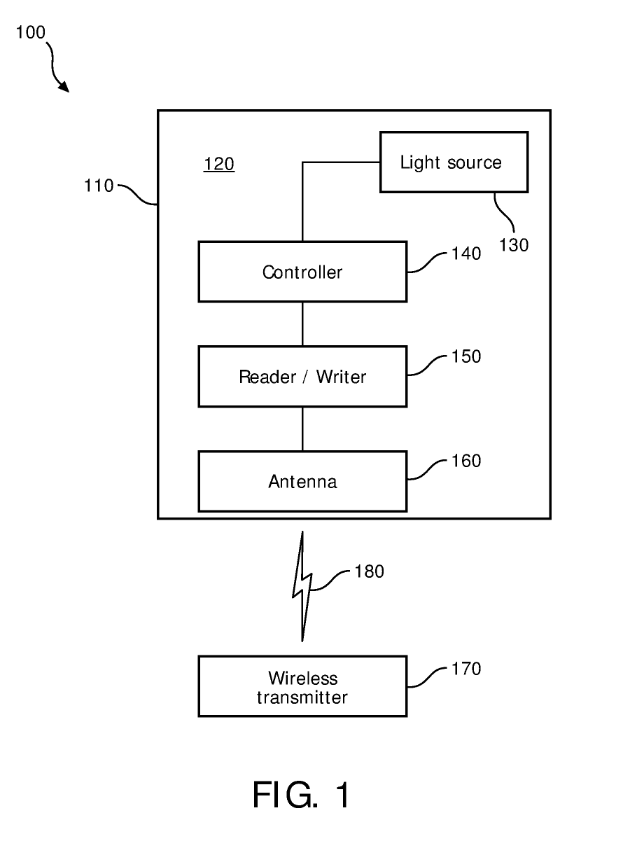

Referring to FIG. 1, in one embodiment, a portable luminaire 100 (also referred to simply as “luminaire 100”) is illustrated in communication with a wireless transmitter 170. The luminaire 100 may comprise a housing 110 defining an interior 120. In some embodiments the interior 120 may contain one or more light sources 130 (also referred to herein simply as “light source 130”) and a controller 140 that controls the light source 130. For example, the light source 130 may be an LED-based source (including one or more LEDs as defined above), and controller 140 may include one or more LED drivers (not depicted) to energize the one or more LEDs based on a lighting control signal. Although some aspects of the disclosed embodiments may be described with reference to the term “LED”, it should be understood that such aspects may also apply to other types of light sources. The interior 120 may include a wireless communication interface, which in FIG. 1 is depicted in the form of a wireless reader/writer 150, to activate and/or receive a wireless signal 180 from a wireless transmitter 170. In some embodiments the luminaire 100 may include an antenna 160 to receive the wireless signal 180 and transmit the wireless signal 180 to the reader/writer 150.

The controller 140 may be operably coupled with the light source 130 and the wireless reader/writer 150. The controller 140 may be configured to determine, based on the wireless signal 180, one or more desired properties of light to be emitted by light source 130, and to generate the lighting control signal based on the one or more desired properties of light. In some implementations, the wireless signal 180 may include instructions for the one or more desired properties of light to be emitted by the one or more LEDs. The wireless reader/writer 150 may communicate the wireless signal 180 and/or data indicative of the instructions to the controller 140. The controller 140 may be configured to determine, based on the wireless signal 180 and/or the data indicative of the instructions, the one or more desired properties of light to be emitted by one or more LEDs associated with light source 130. For example, the controller 140 may employ one or more microprocessors that may be programmed using software (e.g., microcode) to perform various functions discussed herein. The controller 140 may generate a lighting control signal that includes instructions for the one or more desired properties of light. Based at least in part on the lighting control signal, LED drivers may energize the one or more LEDs in the light source 130 to emit light based on the one or more desired properties of light.

In various implementations, the wireless transmitter 170 may be a passive NFC tag or an active NFC controller. In various implementations, the wireless reader/writer 150 may be an NFC reader/writer or an active NFC controller configured to decode the wireless signal 180 transmitted by the passive NFC tag. For example, a passive NFC tag or active NFC controller may transmit a set of lighting instructions to the NFC reader/writer. The NFC reader/writer may decode the lighting instructions and transmit the decoded instructions to the controller 140. While various examples described herein refer to “NFC tags” and “passive NFC tags,” it should be understood that NFC controllers may also be planted at various locations and/or incorporated with various objects such as toys.

Along with the physical components of the one or more light sources, luminaires may include wiring that connects the one or more light sources to a power source. Some luminaires may include optical elements such as an optional reflector that may help direct and distribute the light, or a collimator. Some luminaires may be portable. For example, the luminaire may be a flashlight. Also, for example, the luminaire 100 may be fitted onto and/or form a device. For example, the luminaire 100 may be attached to or be formed as a child's toy (e.g., a doll or action figure).

Properties of light may include one or more of a desired color, a color temperature, hue, brightness, a blinking sequence, a period and/or aperiodic sequence. One or more such properties of light may be combined to produce a desired property of light. For example, the desired property of light may be a repeated sequence of flashing red and blue lights. As another example, the desired property of light may be different brightness settings (e.g., dim, medium brightness, high brightness).

In some implementations, the luminaire 100 may further include memory (not depicted) storing a library of lighting scenes. Some types of memory may be fixed within the controller 140 or may be transportable, such that the one or more programs stored thereon can be loaded into a controller so as to implement various aspects of the present invention described herein. The lighting scenes may each include one or more properties of light to be emitted by one or more light sources 130. The controller 140 may be configured to select a lighting scene from the library of lighting scenes based on information contained in the wireless signal 180.

In addition to or instead of selecting a lighting scene from a library, in some embodiments, the luminaire 100 may communicate with one or more wireless transmitters 170 using a predefined lighting control language. Such a lighting control language may include established commands and/or parameters that may cause luminaire 100 to energize one or more light sources 130 to emit having various properties. For instance, a sequence of commands could include, “[red:100, green:80, blue:100, bri: 180].” Luminaire 100 may receive this command from a passive NFC tag or an active NFC controller, and may interpret the command accordingly. This would provide a more flexible approach than prestoring a plurality of lighting scenes on luminaire 100. This would also enable an embodiment in which luminaire 100 may transmit, to a wireless receiver associated with wireless transmitter 170, one or more desired properties of light to be emitted by one or more light sources associated with the wireless transmitter 170. Thus, in addition to emitting light as dictated by a nearby NFC controller, luminaire 100 may cause one or more light sources associated with the nearby NFC controller to emit light having various selected properties. While examples described herein may refer primarily to a luminaire selecting a lighting scene from a library based on wireless signal 180, it should be understood that in those same examples (and any others), the luminaire 100 could instead interpret and execute lighting control commands and/or parameters contained in wireless signal 180.

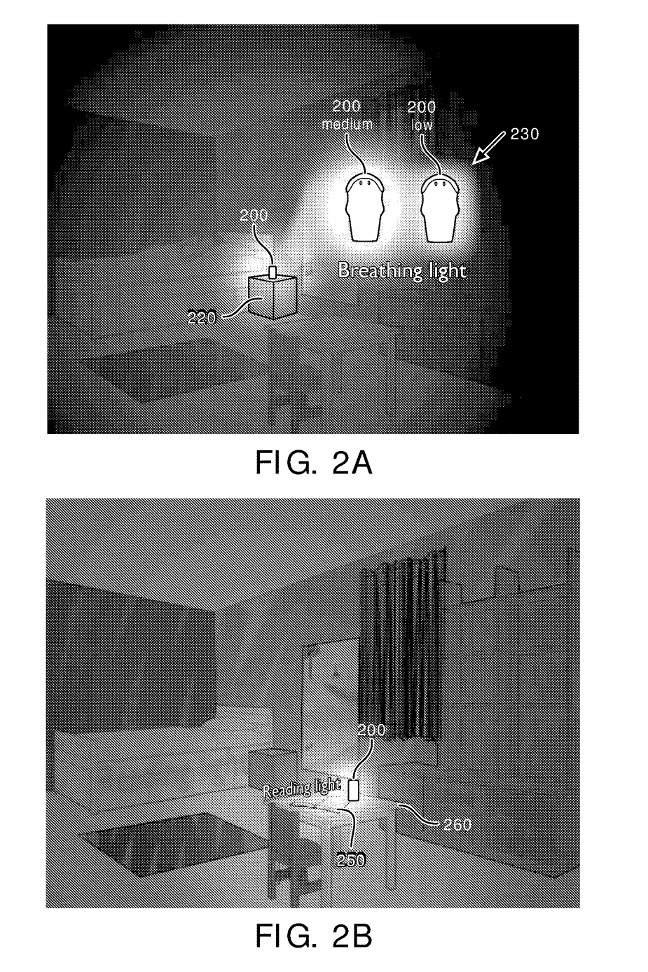

Referring to FIG. 2A, in one embodiment, a luminaire 200 configured with selected aspects of the present disclosure is illustrated displaying a first lighting behavior in response to a wireless transmitter located at a first location. Since luminaire 200 may be similar to luminaire 100 of FIG. 1, one or more aspects of FIGS. 2A and 2B are described with reference to FIG. 1. The luminaire 200 may include in its library one or more predefined lighting scenes such as “Night”, “Reading”, “Timer”, and “Find your way.” A first passive NFC tag (not depicted) located near a bedside table 220 may transmit a wireless signal 180 for the “Night” setting. When the luminaire 200 is located at or near the bedside table 220, the NFC reader/writer 150 (see FIG. 1) in the luminaire 200 may receive the wireless signal 180 (see FIG. 1). Based on data contained in signal 180, controller 140 (see FIG. 1) may select the “Night” lighting scene from the library. The controller 140 may be configured to generate instructions corresponding to the “Night” setting. Such instructions may include one or more light settings suitable for, e.g., a night light. Accordingly, the one or more LED drivers may energize the one or more LEDs of light source 130 (see FIG. 1) to emit light in accordance with the “Night” setting.

Luminaire 200 is illustrated in two states in blow-up 230: a “medium” brightness setting 200_{medium}, where the LEDs transmit light of medium brightness, and a “low” brightness setting 200_{low}, where the LEDs transmit light of low brightness. A lower color temperature such as “low” may include, e.g., white light having a more significant red component, for a “warmer feel.” In some implementations controller 140 may be configured to generate lighting instructions corresponding to the “Night” lighting scene that may cause light source 130 to project stars on the ceiling of a room.

Referring to FIG. 2B, in one embodiment, the luminaire 200 is illustrated displaying a second lighting behavior in response to a wireless transmitter located on a reading table 260 disposed some distance from the bed. As described herein, the luminaire 200 may include one or more settings such as “Night”, “Reading”, “Timer”, and “Find your way” in the library of lighting scenes. A second passive NFC tag (not depicted) located near the reading table 260 may transmit a wireless signal 180 (see FIG. 1) for the “Reading” setting. When the luminaire 200 is placed at or near the reading table 260, the reader/writer 150 (see FIG. 1) in the luminaire 200 may receive the wireless signal 180, decode it, and in response, retrieve the “Reading” setting from the library. The controller 140 (see FIG. 1) may be configured to generate instructions corresponding to the “Reading” setting. Accordingly, the one or more LED drivers may energize the one or more LEDs of light source 130 (see FIG. 1) to emit light in accordance with the “Reading” setting. For example, the LEDs may emit light sufficient to read a book 250 at the reading table 260. For example, a higher color temperature may be generated (e.g., white light having a more significant blue component) for a “cooler feel”. The intensity may also depend on the ambient light. For example, the intensity may depend on whether it is night or day, and/or the amount of light in the room.

As another example, a NFC tag (or NFC controller) may be located at a portion of the room to cause illumination of that portion of the room when luminaire 200 is near. The NFC tag may transmit a lighting scene corresponding to the “Find your way” setting via the wireless signal 180. When a luminaire is placed at or near the NFC tag, the NFC reader/writer 150 in the luminaire may receive the wireless signal 180 and decode it to retrieve the “Find your way” setting from the library. The controller 140 may be configured to generate instructions corresponding to the “Find your way” setting. For example, the controller 140 may be configured to energize the one or more LEDs to emit a steady light when the luminaire is proximate to NFC tag. This may allow a person to find their way around that portion of the room.

Generally speaking, an NFC component may be located on or near any object. For example, an NFC tag may be placed on or near a child's toy. When the child places a luminaire near the toy, the luminaire may emit one or more light behaviors in response to the wireless signal from the NFC tag. As noted above, an NFC component may include information related to light behaviors, such as one or more lighting scene identifiers, one or more of light settings/parameters/commands (e.g., hue, brightness, intensity, dim, etc.), light effects (e.g., sequences and/or patterns of light settings), a sound effect, a shape, and a texture. The information may be transmitted as a wireless signal (e.g., 180) to the luminaire. The controller 140 in the luminaire may decode the information from the wireless signal and generate a lighting behavior responsive to the signal from the NFC tag. In some implementations, light effect tags may be placed in or on toys to augment the playing experience.

For example, an NFC component with instructions to cause flashing light may be placed on a fire truck. When a luminaire is placed on the fire truck, the signal from the NFC component may cause the luminaire to energize one or more LEDs to simulate a fire truck flashing lights and/or siren. In some implementations a mobile computing device and/or an NFC reader/writer or controller may be utilized to program and/or re-program the NFC component to encode different lighting behaviors. In some embodiments, an NFC reader/writer or controller of a luminaire may provide a signal containing various instructions and/or lighting behavior information to a remote NFC controller placed on or near an object such as a toy. The remote NFC controller may in turn cause one or more light sources associated with that object to emit light having various selected lighting properties, as well as other types of output. Thus, for instance, when a child places a luminaire on a toy fire truck to make the luminaire flash red and white, the luminaire may simultaneously provide a wireless signal to an NFC controller on the toy fire truck to make the toy fire truck energize its own lights or to emit the sound of a siren from one or more speakers associated with the toy fire truck.

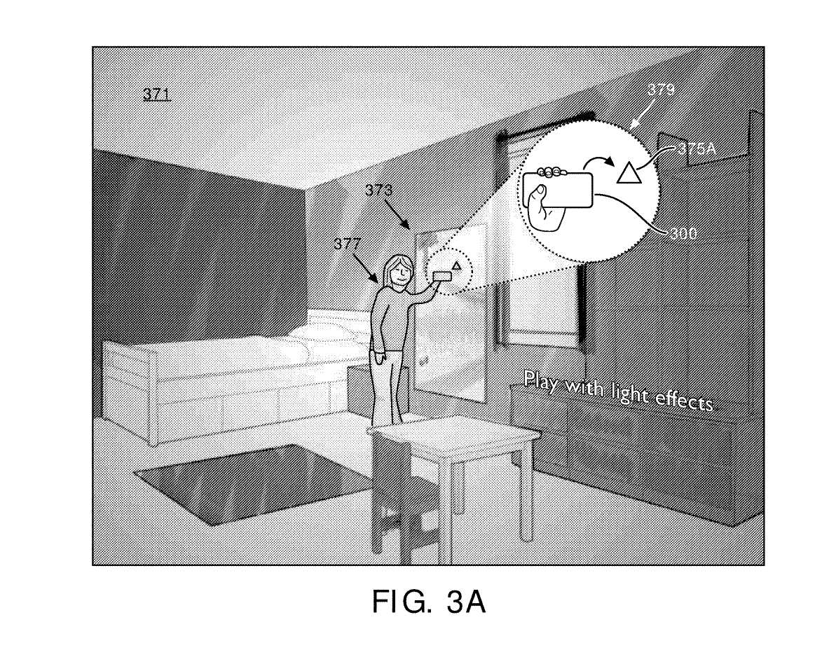

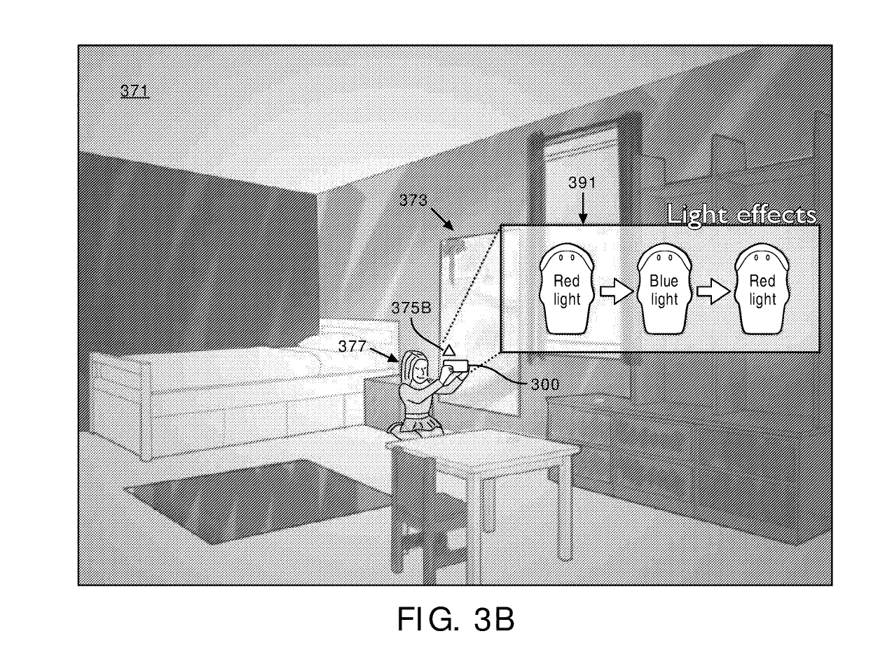

Referring to FIG. 3A, A child's room 371 is illustrated with a play mat 373 mounted on a wall. In one embodiment, a luminaire 300 is illustrated displaying a first light behavior. This may be in response luminaire 300 being held by a child 377 in close proximity to a first wireless transmitter in the form of a first NFC tag 375A embedded in a first portion of play mat 373. A blow-up 379 illustrates a portion of the play mat 373 near the first NFC tag 375A. In some implementations the first NFC tag 375A may be a touch-sensitive tag. The luminaire 300 may respond to the first NFC tag 375A to emit light that illuminates the portion of the play mat 373 near the first NFC tag 375A.

Referring to FIG. 3B, in one embodiment, luminaire 300 is illustrated displaying a second light behavior. This may be in response to luminaire 300 being held by a child 377 in close proximity to a second wireless transmitter in the form of a second NFC tag 375B embedded at a second portion of the play mat 373. As illustrated at 391, various light behaviors, such as a sequence of different colors (e.g., red and blue lights), may be produced. The terms “different colors” implicitly refer to multiple spectra having different wavelength components and/or bandwidths. It also should be appreciated that the term “color” may be used in connection with both white and non-white light.

Additional and/or alternative light behaviors may be produced in response to one or more NFC tags embedded in different portions of the play mat 373. For example, a sound effect may be output by the luminaire 300 in response to another embedded NFC tag. Also, for example, the light from the luminaire 300 may simulate a texture on a portion of the play mat 373. As another example, the light from the luminaire 300 may cast a light-and-shade effect on a portion of the play mat 373 to simulate an object.

In another aspect, an NFC component located near a gaming device (e.g., a laptop display, a television, a mobile device display) may transmit a time-dependent lighting scene corresponding to the wireless signal 180 for the “Timer” setting. When a luminaire (e.g., 100, 200, 300) is placed at or near the gaming device, the NFC reader/writer 150 in the luminaire may receive the wireless signal 180 and decode it to retrieve the “Timer” setting from the library. The controller 140 may be configured to generate instructions corresponding to the “Timer” setting. For example, the controller 140 may be configured to initiate a timer for a predetermined time interval (e.g., fifteen minutes, thirty minutes, one hour, etc.), and commence energizing of one or more light sources 130 at an end of the time interval. As another example, the controller 140 may be configured to initiate a timer for a predetermined time interval during which the selective energizing will occur, and cease the selective energizing at an end of the time interval. Either of these variations may inform a child playing a video game that an allotted time for playing the game is over.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Reference numerals appearing between parentheses in the claims, if any, are provided merely for convenience and should not be construed as limiting the claims in any way.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A portable luminaire comprising one or more LEDs and a housing defining an interior, the interior containing:
one or more LED drivers to energize the one or more LEDs based on a lighting control signal;
a wireless communication interface including a near field communication reader to receive a wireless signal from a wireless transmitter; and
a controller operably coupled with the one or more LED drivers and the wireless communication interface, the controller configured to:
determine, based on the wireless signal, one or more desired properties of light to be emitted by the one or more LEDs; and
generate the lighting control signal based on the one or more desired properties of light.

2. The portable luminaire of claim 1, wherein the wireless communication interface comprises a near field communication writer.

3. The portable luminaire of claim 1, wherein the wireless communication interface comprises a near field communication controller.

4. The portable luminaire of claim 1, further comprising memory storing a library of lighting scenes, wherein the controller is further configured to:
select a lighting scene from the library based on information contained in the wireless signal; and
generate the lighting control signal to cause the one or more LED drivers to energize the one or more LEDs to emit light in accordance with the selected lighting scene.

5. The portable luminaire of claim 4, wherein the lighting scene is a time-dependent lighting scene.

6. The portable luminaire of claim 5, further comprising a timer set to expire after a predetermined time interval, and wherein the controller is further configured to generate the lighting control signal until a first of expiration of the timer or movement of the portable luminaire away from the wireless transmitter.

7. The portable luminaire of claim 5, further comprising a timer set to expire after a predetermined time interval, and wherein the controller is further configured to generate the lighting control signal after expiration of the timer.

8. The portable luminaire of claim 1, wherein the controller is further configured to:
interpret one or more lighting control parameters or commands contained in the wireless signal; and
generate the lighting control signal to cause the one or more LED drivers to energize the one or more LEDs to emit light having properties selected based on the interpreted one or more lighting control parameters or commands.

9. The portable luminaire of claim 1, wherein the wireless communication interface is configured to exchange data using one or more of radio frequency identification (“RFID”) or BlueTooth.

10. The portable luminaire of claim 3, wherein the controller is further configured to transmit, via the near field communication controller to a wireless receiver associated with the wireless transmitter, one or more desired properties of light to be emitted by one or more light sources associated with the wireless transmitter.

11. The portable luminaire of claim 3, wherein the controller is further configured to transmit, via the near field communication controller to a wireless receiver associated with the wireless transmitter, one or more desired sound effects to be emitted by one or more speakers associated with the wireless transmitter.

12. A lighting control method, comprising:
placing a portable luminaire within wireless range of a wireless transmitter;
obtaining, by a near field communication reader of the luminaire from the wireless transmitter, one or more desired properties of light to be emitted by one or more LEDs; and
selectively energizing the one or more LEDs based on the one or more desired properties of light.

13. The lighting control method of claim 12, further comprising:
initiating a timer for a predetermined time interval in response to the obtaining; and
commencing the selective energizing at an end of the time interval.

14. The lighting control method of claim 12, further comprising:
initiating a timer for a predetermined time interval during which the selective energizing will occur; and
ceasing the selective energizing at an end of the time interval.

15. The lighting control method of claim 12, further comprising:
selecting a lighting scene from a library of lighting scenes based on information obtained from the wireless transmitter; and
selectively energizing the one or more LEDs to emit light in accordance with the selected lighting scene.

16. The lighting control method of claim 12, further comprising:
interpreting one or more lighting control parameters or commands contained in the wireless signal; and
selectively energizing the one or more LEDs to emit light having properties selected based on the interpreted one or more lighting control parameters or commands.

17. The lighting control method of claim 12, further comprising placing the portable luminaire onto a toy that includes the transmitter on its surface.

18. The lighting control method of claim 17, further comprising transmitting, from the portable luminaire to a wireless receiver associated with the wireless transmitter on the toy, one or more desired properties of light to be emitted by one or more light sources associated with the toy.

19. The lighting control method of claim 17, further comprising transmitting, from the portable luminaire to a wireless receiver associated with the wireless transmitter on the toy, one or more desired sound effects to be emitted by one or more speakers associated with the toy.
